(19) United States
(12) Patent Application Publication
(10) Pub. No.: US 2007/0182516 A1
(43) Pub. Date: Aug. 9, 2007

(54) Magnetic resonance imaging device with an active shielding device

(75) Inventors: Nicolaas Bernardus Roozen, Eindhoven (NL); Adrian Toma, Eindhoven (NL); Georgo Zorz Angelis, Eindhoven (NL)

Correspondence Address: PHILIPS INTELLECTUAL PROPERTY & STANDARDS, 595 MINER ROAD, CLEVELAND, OH, 44143, US

(73) Assignee: Koninklijke Philips Electronics N.V., Eindhoven (NL)

(21) Appl. No.: 10/598,673

(22) PCT Filed: Mar. 11, 2005
(86) PCT No.: PCT/IB05/50872

§ 371 Date: Sep. 7, 2006

(30) Foreign Application Priority Data
Mar. 16, 2004 (EP) 04101067.9

(51) Int. Cl. H01F 3/00

(52) U.S. Cl. 335/296

(57) ABSTRACT

The present invention relates to a magnetic resonance imaging (MRI) device. The basic components of an MRI device are the main magnet system, the gradient system, the RF system and the signal processing system. According to the present invention the magnetic resonance imaging device comprises at least one active shielding device (19, 20) assigned to the main magnet system (2), wherein the or each is driven by an electrical current in order to reduce magnetic field penetration inside the main magnet system and to reduce mechanical forces induced in the main magnet

The invention relates to a magnetic resonance imaging device, comprising at least a main magnet system for generating a steady magnetic field in a measuring space of the magnetic resonance imaging device, a gradient system comprising gradient coils for generating a magnetic gradient field in said measuring space, and at least one active shielding device assigned to the main magnet system.

The basic components of a magnetic resonance imaging (MRI) device are the main magnet system, the gradient system, the RF system and the signal processing system. The main magnet system is also often called cryostat. The main magnet system comprises a bore hole defining a measuring space and enabling the entry of an object to be analyzed by the MRI device. The main magnet system generates a strong uniform static field for polarization of nuclear spins in the object to be analyzed. The gradient system is designed to produce time-varying magnetic fields of controlled spatial non-uniformity. The gradient system is a crucial part of the MRI device because gradient fields are essential for signal localization. The RF system mainly consists of a transmitter coil and a receiver coil, wherein the transmitter coil is capable of generating a magnetic field for excitation of a spin system, and wherein the receiver coil converts a precessing magnetization into electrical signals. The signal processing system generates images on basis of the electrical signals.

Magnetic resonance imaging (MRI) devices known from prior art usually generate a relatively high acoustic noise level which has to be minimized. On the one hand, acoustic noise is caused by vibrations of the gradient system, and on the other hand acoustic noise is caused by vibrations of the main magnet system (cryostat).

The acoustic noise generated by the gradient system vibrations can effectively be reduced by means of a vacuum chamber. See for example U.S. Pat. No. 6,404,200 and U.S. Pat. No. 5,793,210.

In order to further reduce the acoustic noise of the MRI devices, the acoustic noise generated by the vibrating main magnet system needs to be reduced. The main magnet system vibrations are caused by three excitation mechanisms, firstly by a structural transmission of vibrations from the gradient system to the main magnet system through gradient coil mounts, secondly by a magnetic excitation of the main magnet system due to the varying magnetic gradient-fields causing eddy currents in the wall of the main magnet system, and thirdly by an acoustic excitation of the main magnet system. The third excitation mechanism is not dominant for most MRI devices.

The first excitation mechanism causing vibrations of the main magnet system can be reduced effectively by using a compliant support for the gradient coils of the gradient system. See for example EP-A-1 193 507.

The present invention is related to the reduction of vibrations and acoustic noise caused by the second excitation mechanism, namely by the magnetic excitation of the main magnet system due to the varying magnetic gradient-fields causing eddy currents in the wall of the main magnet system.

From U.S. Pat. No. 6,326,788 it is known that the magnetic excitation of the main magnet system can effectively be reduced by means of an eddy current shield system mounted rigidly on the gradient system. However, it is difficult to reduce eddy currents in the flange of the main magnet system by means of an eddy current shield system mounted on the gradient system.

From EP-A-1 193 507 it is known that the magnetic excitation of the main magnet system can effectively be reduced by using a non-conducting main magnet system. This has however drawbacks with respect to a boil-off effect, because heat is generated inside the main magnet system as a result of the fact that the main magnet system is non-conducting.

It is an object of the present invention to reveal an alternative way to reduce the magnetic excitation of the main magnet system and, additionally, to reduce the magnetic field penetration inside the main magnet system.

In order to achieve said object, a magnetic resonance imaging device in accordance with the invention is characterized in that the or each active shielding device is driven by an electrical current in order to reduce magnetic field penetration inside the main magnet system and to reduce mechanical forces induced in the main magnet system.

Preferably, the gradient coils are driven by a gradient coil current, the electrical current used to drive the or each active shielding device and the gradient coil current having the same frequency spectrum, wherein the electrical current used to drive the or each active shielding device and the gradient coil current are characterized by a different magnitude and a phase shift, and wherein said magnitude and said phase shift are determined to reduce magnetic field penetration inside the main magnet system and to reduce mechanical forces induced in the main magnet system.

In accordance with an improved embodiment of the present invention, the or each active shielding device is driven by an electrical current generated by an electrical circuit connected in series or in parallel with the gradient system, wherein the electrical circuit comprises an error corrector unit, wherein vibrations of the main magnet system are measured, and wherein the error corrector unit adopts the electrical current used to drive the or each active shielding device in order to minimize vibrations of the main magnet system.

Embodiments of a magnetic resonance imaging device in accordance with the invention will be described in detail in the following with reference to the drawings, in which:

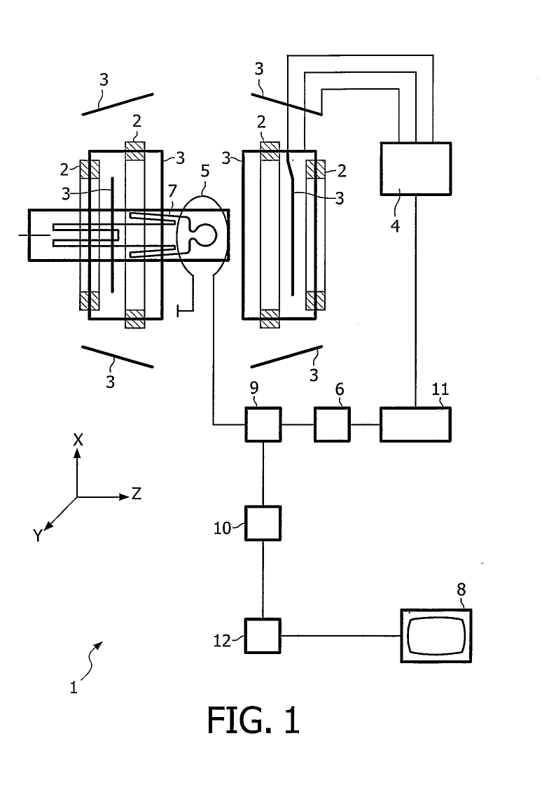

FIG. 1 shows an MRI device according to the prior art;

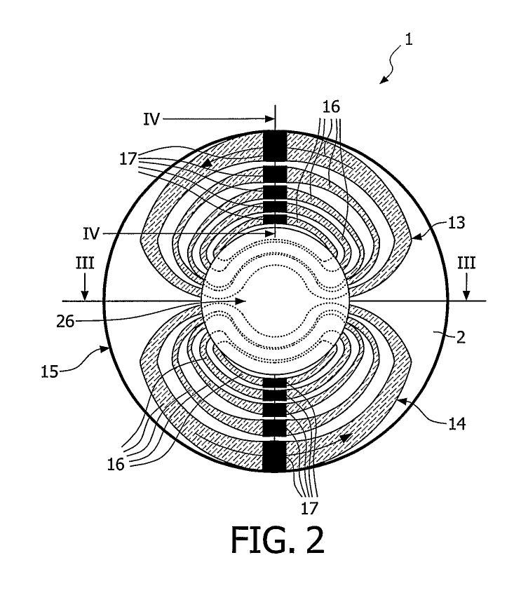

FIG. 2 shows a view onto a lateral flange of an MRI device according to a first embodiment of the present invention;

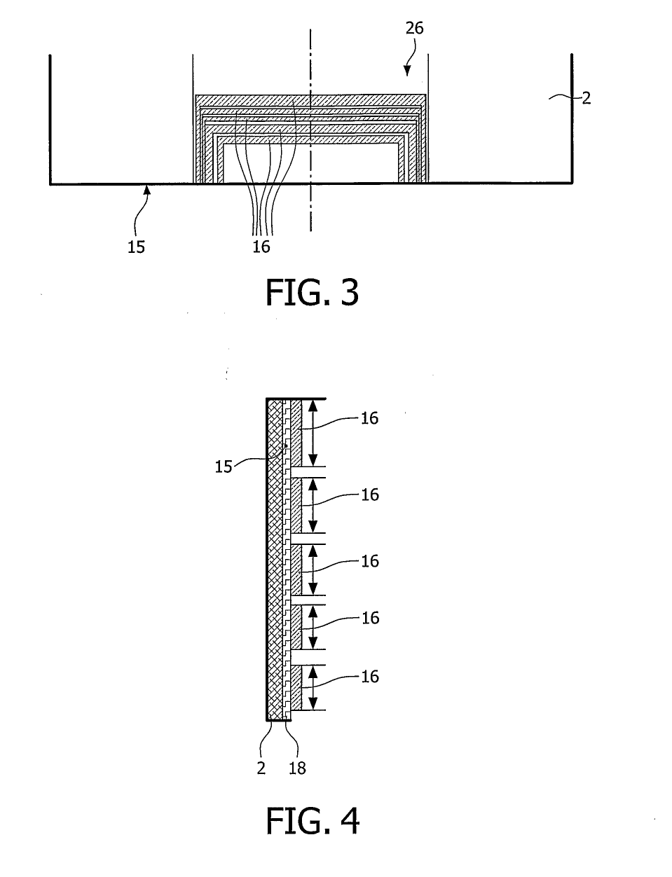

FIG. 3 shows a cross-sectional view through the MRI device according to the first embodiment of the present invention along the line of intersection III-III in FIG. 2;

FIG. 4 shows a cross-sectional view through the MRI device according to the first embodiment of the present invention along the line of intersection IV-IV in FIG. 2;

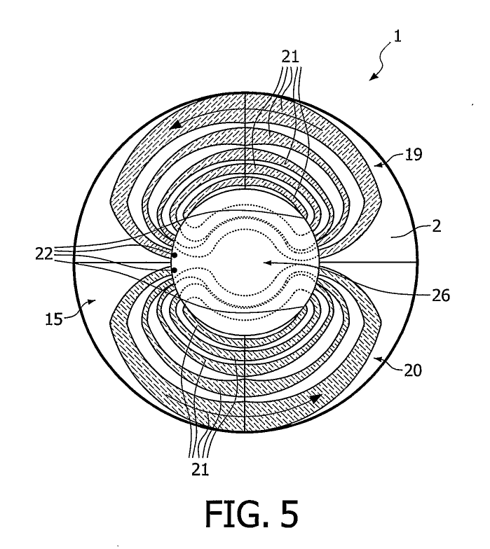

FIG. 5 shows a view onto a lateral flange of an MRI device according to a second embodiment of the present invention; and

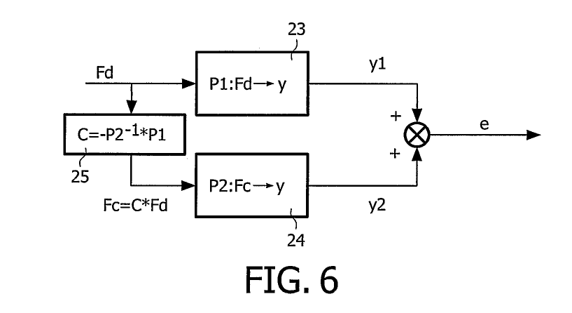

FIG. 6 shows a block diagram of an error corrector used in connection with a preferred embodiment of the present invention.

FIG. 1 shows a magnetic resonance imaging (MRI) device 1 known from prior art which includes a main magnet system 2 for generating a steady magnetic field, and also several gradient coils providing a gradient system 3 for generating additional magnetic fields having a gradient in the X, Y, Z directions. The Z direction of the coordinate system shown corresponds to the direction of the steady magnetic field in the main magnet system 2 by convention. The Z axis is an axis co-axial with the axis of a bore hole of the main magnet system 2, the X axis being the vertical axis extending from the center of the magnetic field, and the Y axis being the corresponding horizontal axis orthogonal to the Z axis and the X axis.

The gradient coils of the gradient system 3 are fed by a power supply unit 4. An RF transmitter coil 5 serves to generate RF magnetic fields and is connected to an RF transmitter and modulator 6.

A receiver coil is used to receive the magnetic resonance signal generated by the RF field in the object 7 to be examined, for example a human or animal body. This coil may be the same coil as the RF transmitter coil 5. Furthermore, the main magnet system 2 encloses an examination space which is large enough to accommodate a part of the body 7 to be examined. The RF coil 5 is arranged around or on the part of the body 7 to be examined in this examination space. The RF transmitter coil 5 is connected to a signal amplifier and demodulation unit 10 via a transmission/reception circuit 9.

The control unit 11 controls the RF transmitter and modulator 6 and the power supply unit 4 so as to generate special pulse sequences which contain RF pulses and gradients. The phase and amplitude obtained from the demodulation unit 10 are applied to a processing unit 12. The processing unit 12 processes the presented signal values so as to form an image by transformation. This image can be visualized, for example by means of a monitor 8.

According to the present invention, the magnetic resonance imaging device comprises at least one active shielding device assigned to the main magnet system, wherein the or each active shielding device is driven by an electrical current in order to reduce magnetic field penetration inside the main magnet system and to reduce mechanical forces induced in the main magnet system.

A first preferred embodiment of the present invention will be described with reference to FIGS. 2 to 4. According to this preferred embodiment of the present invention, two active shielding devices 13, 14 are assigned to each lateral flange 15 of the main magnet system 2. In the region of one each lateral flange 15, a first active shielding device 13 is assigned to the upper part of the main magnet system 2, a second active shielding device 14 is assigned to the lower part of the main magnet system 2. In the embodiment shown in FIG. 2, each of the two active shielding devices 13, 14 comprises five electrical coils 16. The electrical coils 16 of each active shielding device 13, 14 are positioned in a concentric manner. As shown in FIG. 2, each of said concentric electrical coils 16 of each active shielding device 13, 14 comprises an individual terminal 17, so that each of the electrical coils 16 can be driven separately by an individual electrical current.

The dotted lines in FIG. 2 represent the electrical connection of the individual electrical coils 16 and illustrate that the electrical coils 16 extend into the interior of the bore hole 26 of the main magnet system 2. This can also be taken from FIG. 3.

In the embodiment shown in FIGS. 2 to 4 the electrical coils 16 of the active shielding devices 13, 14 are fixedly (rigidly) attached to the lateral flanges 15 of the main magnet system 2. It can be taken from FIG. 4 that an electrical insulator 18 is sandwiched between the lateral flange 15 of the main magnet system 2 and the electrical coils 16 of the active shielding devices 13, 14.

FIG. 5 shows an alternative embodiment of a magnetic resonance imaging device 1 comprising a main magnet system 2 and active shielding devices 19, 20 fixedly (rigidly) attached to the lateral flanges 15 of the main magnet system 2. In the region of each lateral flange 15, a first active shielding device 19 is assigned to the upper part of the main magnet system 2 and a second active shielding device 20 is assigned to the lower part of the main magnet system 2. Each of the active shielding devices 19, 20 comprises five electrical coils 21, wherein said electrical coils 21 of each active shielding device 19, 20 are connected in series with each other. This creates a spiral coil arrangement with only two terminals 22 for each active shielding device 19 and 20. This means that the same current flows through the five electrical coils 21 of each of said active shielding devices 19, 20. The electrical connections of the coils 21 are shown by the dotted lines in FIG. 5.

In the embodiments discussed with reference to FIGS. 2 to 5, the electrical coils 16/21 are fixedly (rigidly) attached to the lateral flanges 15 of the main magnet system 2. It should be noted that it is also possible to flexibly attach the electrical coils to the main magnet system, by example using an electrical insulator made from a viscous or visco-elastic material. Further on, it is possible that the active shielding devices are not attached at all to the lateral flanges of the main magnet system, but only positioned in the region of the lateral flanges.

As mentioned above, the active shielding devices 13, 14, 19, 20 are driven by an electrical current in order to reduce magnetic filed penetration inside the main magnet system 2 and to reduce mechanical forces induced in the main magnet system 2. The current used to drive the active electrical coils 16, 21 of the active shielding devices 13, 14, 19, 20 has the same frequency spectrum than the current used to drive the gradient coils of the gradient system 3. An electrical circuit is connected in series or in parallel to the gradient system 3 providing the electrical current to drive the electrical coils 16, 21 of the active shielding devices 13, 14, 19, 20.

It should be noted that two effects can be achieved by driving the active shielding devices 13, 14, 19, 20 with the electrical current. On the one hand, it is possible to minimize mechanical forces induced in the main magnet system 2. On the other hand, it is possible to reduce the magnetic field penetration inside the main magnet system 2. It should be noted these two effects counteract each other. For that, the electrical current used to drive the active shielding devices 13, 14, 19, 20 has to be adjusted in a way that a good compromise is achieved between the minimization of the mechanical forces and the minimization of the magnetic field penetration. In order to achieve that, the electrical current used to drive the active shielding devices 13, 14, 19, 20 and the electrical current used to operate the gradient coils of the gradient system 3 have the same frequency spectrum, however, these two currents are characterized by a different magnitude and a phase shift. By adopting the magnitude and/or the phase shift, it is possible to achieve a good compromise between the minimization of the magnetic field penetration of the main magnet system 2 and the minimization of the mechanical forces induced in the main magnet system 2.

According to the first objective of the present invention, the electrical coils 16, 21 of the active shielding devices 13, 14, 19, 20 are driven in a way such that the magnetically induced forces (magnetic pressure) due to eddy currents running in the wall of the main magnet system are counteracted. The magnetically induces forces are mainly a result of the eddy currents and the static magnet field of the main magnet system 2. Counteracting the magnetically induced forces on the main magnet system 2 is accomplished by replicating or imitating the eddy currents running in the main magnet system 2 by means of said electrical coils 16, 21. The advantages of canceling the magnetic pressure on the main magnet system 2 is obvious. Firstly, the acoustic noise problem is tackled at the source, which is very effective. Secondly, the magnetic pressure amplitude and distribution is mainly independent from the frequency. For that, the electrical coils 16, 21 can be driven by a electrical current having the same frequency spectrum as the current used to drive the gradient coils of the gradient system 3. According to the second objective of the present invention, the electrical coils 16, 21 of the active shielding devices 13, 14, 19, 20 are driven in a way such that the magnetic filed penetration into the main magnet system 2 is reduced. The minimization of said magnetic field penetration prevents the so-called Helium boil-off effect.

The present invention could have the effect that the electrical currents running through the electrical coils 16, 21 may disturb the magnetic field in the bore hole of the main magnet system 2. However, this effect is not very serious, because the magnetic field distortion is synchronous with the gradient field. In addition, the electrical coils 16, 21 are relatively far away from the isocenter of the bore hole.

According to an improved embodiment of the present invention, the electrical circuit which is used to generate the electrical current to drive the electrical coils 16, 21 of the active shielding devices 13, 14, 19 and 20 comprises an error corrector unit. FIG. 6 shows a block diagram of such an error corrector unit to illustrate the function of said unit.

The block 23 of the block diagram according to FIG. 6 illustrates the transfer function P1 of the gradient system 3 causing vibrations y1 of the main magnet system 2. The gradient coils of the gradient system 3 are driven with a gradient coil current Fd. The block 24 shown in FIG. 6 shows a transfer function P2 of the active shielding devices 13, 14, 19, 20 causing vibrations y2 of the main magnet system 2, wherein the vibrations y2 counteract the vibrations y1 in a way that the difference e between the vibrations y1 and y2 should be zero in the ideal world. However, due to the fact that the difference will not be zero, an error corrector unit is used to minimize the error e.

An error e will result in vibrations of the main magnet system 2. These vibrations will be measured off-line by sensors attached to the main magnet system 2. These sensors can be strain sensors, acceleration sensors, velocity sensors, displacement sensors or the like, and the sensors will be removed from the MRI device after thee measurements have been performed. In order to minimize the error e, the measurements are used to establish a feed forward filter as an error corrector which is illustrated by block 25 in FIG. 6.

With an appropriately designed feed forward filter (error corrector) the current Fd will be filtered in such a way that the error vibrations e are reduced. The current Fd will be filtered by C, wherein C=−INV(P2)*P1. The error corrector unit, namely the feed forward filter according to block 25, adopts the electrical current Fc used to drive the electrical coils 16, 21 of the active shielding devices 13, 14, 19, 20 in a way that the amplitude and/or phase shift compared to the gradient coil current Fd is modified.

1. A magnetic resonance imaging device, comprising at least:
a) a main magnet system for generating a steady magnetic field in a measuring space of the magnetic resonance imaging device;
b) a gradient system comprising gradient coils for generating a magnetic gradient field in said measuring space; and
c) at least one active shielding device assigned to the main magnet systems;
wherein the or each active shielding device is driven by an electrical current in order to reduce magnetic field penetration inside the main magnet system and to reduce mechanical forces induced in the main magnet system.

2. A magnetic resonance imaging device according to claim 1, wherein the gradient coils are driven by a gradient coil current, the electrical current used to drive the or each active shielding device and the gradient coil current having the same frequency spectrum.

3. A magnetic resonance imaging device according to claim 2, wherein the electrical current used to drive the or each active shielding device and the gradient coil current include a different magnitude and a phase shift, said magnitude and said phase shift being determined to reduce magnetic field penetration inside the main magnet system and to reduce mechanical forces induced in the main magnet system.

4. A magnetic resonance imaging device according to claim 1, wherein the or each active shielding device comprises at least one electrical coil.

5. A magnetic resonance imaging device according to claim 4, wherein the or each electrical coil is fixedly or flexibly attached to the main magnet system, wherein an electrical insulator is sandwiched between the or each electrical coil and the main magnet systems.

6. A magnetic resonance imaging device according to claim 5, wherein the or each electrical coil is fixedly or flexibly attached to lateral flanges of the main magnet system.

7. A magnetic resonance imaging device according to claim 6, wherein the or each electrical coil is in addition fixedly or flexibly attached to the main magnet system in the region of the bore hole.

8. A magnetic resonance imaging device according to claim 5, wherein the or each electrical coil is fixedly or flexibly attached to the bore hole of the main magnet system.

9. A magnetic resonance imaging device according to claim 1, wherein at each lateral flange of the main magnet system there is positioned at least one active shielding device comprising at least one electrical coil.

10. A magnetic resonance imaging device according to claim 9, each active shielding device comprises a set of coils connected in series building a spiral coil, wherein all coils of said spiral coil are driven by the same electrical current.

11. A magnetic resonance imaging device according to claim 9, wherein each active shielding device comprises a set of concentric coils, wherein each of said concentric coils is separately driven by an individual electrical current.

12. A magnetic resonance imaging device according to claim 1, wherein the or each active shielding device is driven by an electrical current generated by an electrical circuit connected in series or in parallel with the gradient system.

13. A magnetic resonance imaging device according to claim 12, wherein the electrical circuit is designed as a linear electrical circuit.

14. A magnetic resonance imaging device according to claim 12, wherein the electrical circuit comprises an error corrector unit, wherein the error corrector unit adopts the electrical current used to drive the or each active shielding device in order to minimize vibrations of the main magnet system.

15. A magnetic resonance imaging device according to claim 14, wherein the error corrector unit is designed as a feed forward filter.

16. A magnetic resonance imaging device according to claim 15, wherein the feed forward filter is designed on basis of vibration measurements of the main magnet system, wherein these vibration measurements are performed off-line.

17. A magnetic resonance imaging device according to claim 14, wherein the error corrector unit adopts the electrical current used to drive the or each active shielding device in a way that the amplitude and/or phase shift compared to the current used to drive the gradient coils is modified.
